(19) United States
(12) Patent Application Publication
(10) Pub. No.: US 2017/0024260 A1
(43) Pub. Date: Jan. 26, 2017

(54) WORKLOAD MIGRATION ACROSS CLOUD PROVIDERS AND DATA CENTERS

(71) Applicant: Cisco Technology, Inc., San Jose, CA (US)

(72) Inventors: Subramanian Chandrasekaran, San Jose, CA (US); Jaiganesh Mathaiyan, Austin, TX (US); Madhav Madhavshree, San Jose, CA (US)

(21) Appl. No.: 14/805,018

(22) Filed: Jul. 21, 2015

(51) Int. Cl. G06F 9/50; G06F 9/445; G06F 9/455

(52) U.S. Cl. CPC G06F 9/5077; G06F 9/45558; G06F 8/63; G06F 9/5083; G06F 2009/45595

(57) ABSTRACT

Systems, methods, and computer-readable media for virtual workload orchestration. In some embodiments, a first cloud provider can obtain a virtual machine image and convert the virtual machine image to a virtual image format based on an environment associated with a second cloud provider. Next, the first cloud provider can provision a guest operating system associated with the virtual machine image with one or more drivers based on the hypervisor associated with the second cloud provider to yield a converted and provisioned virtual machine image. The first cloud provider can then transmit the converted and provisioned virtual machine image to the second cloud provider to be registered as a template virtual machine at the second cloud provider.

### TECHNICAL FIELD

The present technology pertains to cloud workloads and more specifically pertains to orchestrating workloads across provider environments.

### BACKGROUND

Through virtual technologies, cloud computing is rapidly changing the landscape of network-based services. In particular, cloud computing allows customers to use a cloud provider's virtualized computing assets and services, without having to purchase and own all of the necessary equipment and resources. There are various models used by cloud computing providers to offer services, including, Infrastructure-as-a-Service (IaaS), Software-as-a-Service (SaaS), and Platform-as-a-Service (PaaS). Traditionally, IaaS can provide logical infrastructure resources like virtual machines (VMs), virtual networks, or virtual storage. On the other hand, SaaS can provide application software and databases, and PaaS can provide a computing platform, such as an Operating System (OS), a programming language execution environment, and a server.

Currently, there are numerous solutions for cloud computing customers made available by different cloud providers. Thus, customers typically have multiple options when selecting a cloud provider and solution. However, unfortunately, once a customer has implemented a specific cloud solution from a cloud provider, the customer is locked to that particular cloud provider, as integration and interoperability between cloud providers is generally limited. As a result, customers cannot seamlessly migrate workloads between cloud providers or burst workloads into different cloud providers.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments that are illustrated in the appended drawings. Understanding that these drawings depict only example embodiments of the disclosure and are not therefore to be considered to be limiting of its scope, the principles herein are described and explained with additional specificity and detail through the use of the accompanying drawings in which:

FIG. 1 illustrates a schematic block diagram of an example cloud architecture including nodes/devices interconnected by various methods of communication;

FIGS. 2A-C illustrate diagrams of example hybrid clouds;

FIG. 3 illustrates a schematic diagram of an example module for orchestrating workload movement across providers;

FIG. 4 illustrates a block diagram of a system for orchestrating VM workloads from an enterprise datacenter to a service provider datacenter;

FIG. 5 illustrates an example method embodiment;

FIG. 6 illustrates an example network device; and

FIGS. 7A-B illustrate example system embodiments.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Moreover, it should be understood that features or configurations herein with reference to one embodiment or example can be implemented in, or combined with, other embodiments or examples herein. That is, terms such as “embodiment”, “variation”, “aspect”, “example”, “configuration”, “implementation”, “case”, and any other terms which may connote an embodiment, as used herein to describe specific features or configurations, are not intended to limit any of the associated features or configurations to a specific or separate embodiment or embodiments, and should not be interpreted to suggest that such features or configurations cannot be combined with features or configurations described with reference to other embodiments, variations, aspects, examples, configurations, implementations, cases, and so forth. In other words, features described herein with reference to a specific example (e.g., embodiment, variation, aspect, configuration, implementation, case, etc.) can be combined with features described with reference to another example. Precisely, one of ordinary skill in the art will readily recognize that the various embodiments or examples described herein, and their associated features, can be combined with each other.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

1. Overview

Disclosed are systems, methods, and computer-readable media for virtual workload orchestration or migration across cloud providers or environments. In some embodiments, a first cloud provider can obtain a virtual machine image and convert the virtual machine image to a virtual image format based on an environment associated with a second cloud provider. The environment can include, for example, a disk format, a hypervisor, a platform, etc. Next, the first cloud provider can provision a guest operating system associated with the virtual machine image with one or more drivers based on a hypervisor associated with the second cloud provider to yield a converted and provisioned virtual machine image. The first cloud provider can then transmit the converted and provisioned virtual machine image to the second cloud provider to be registered as a template virtual machine at the second cloud provider.

2. Description

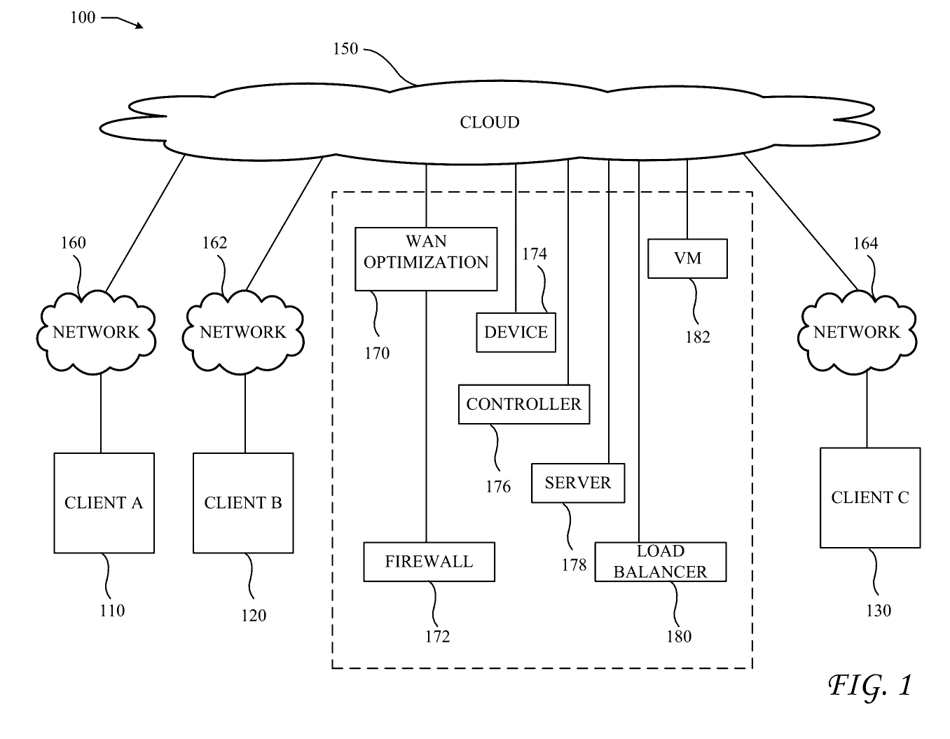

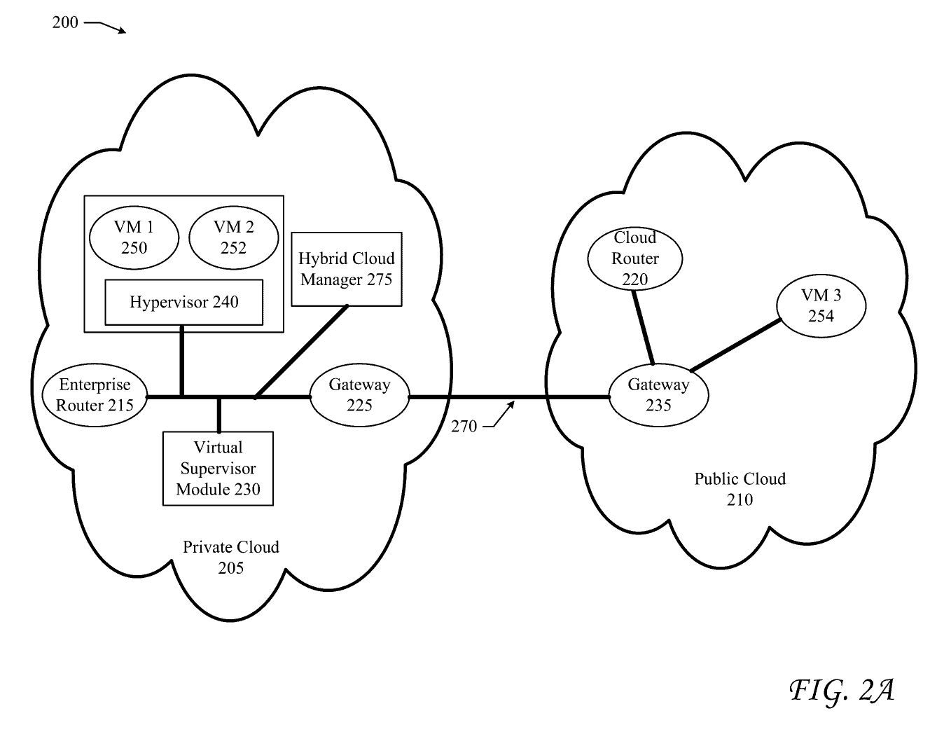

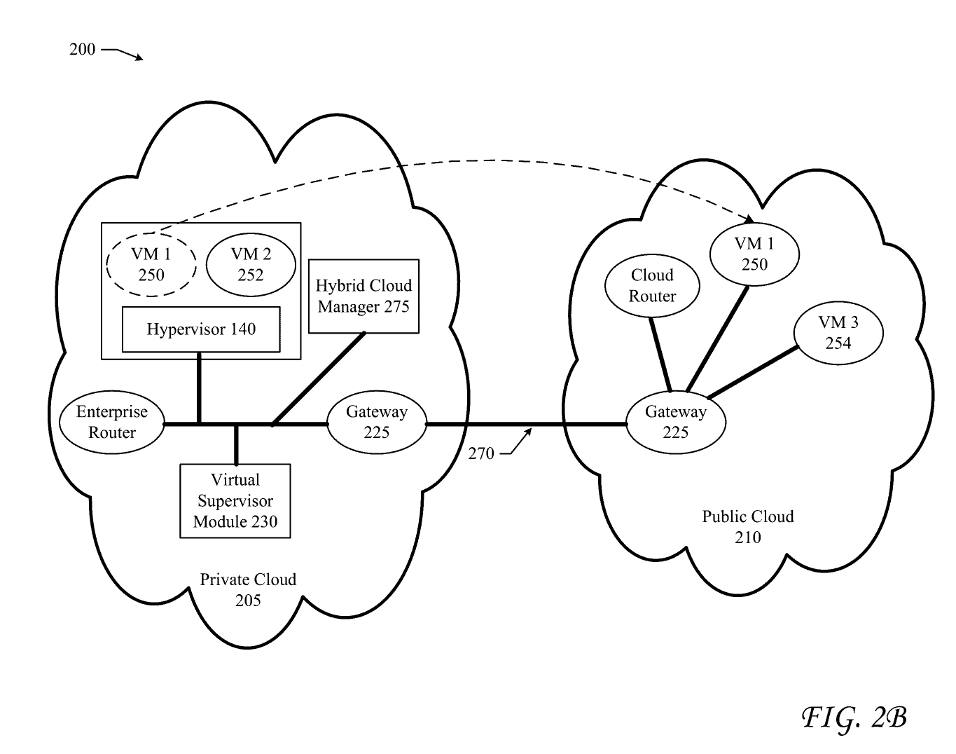

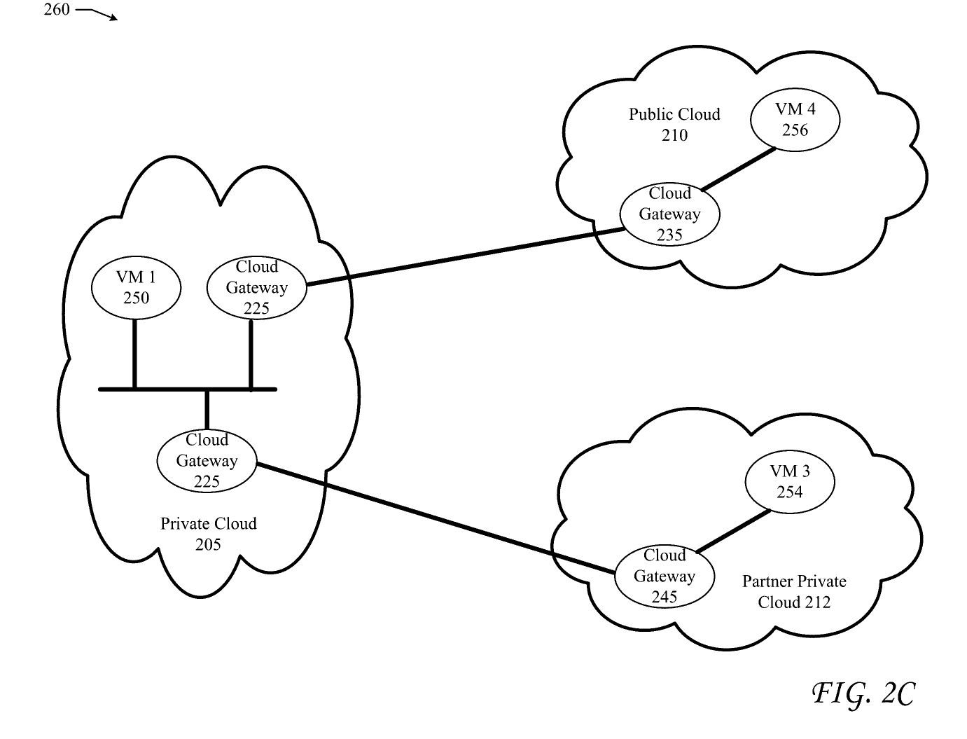

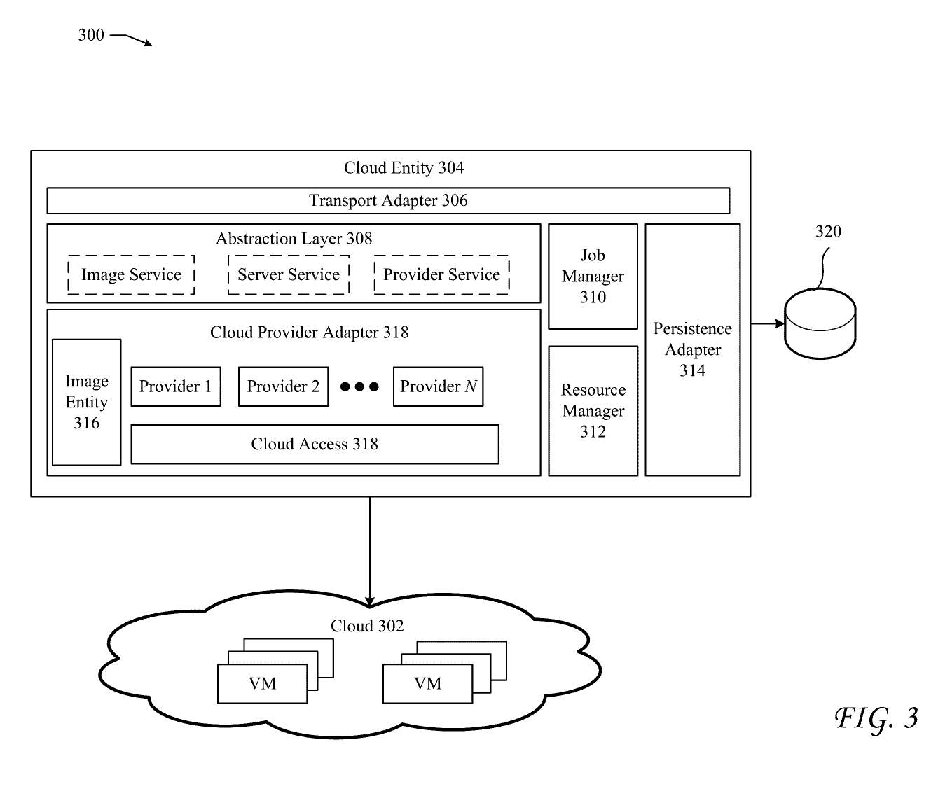

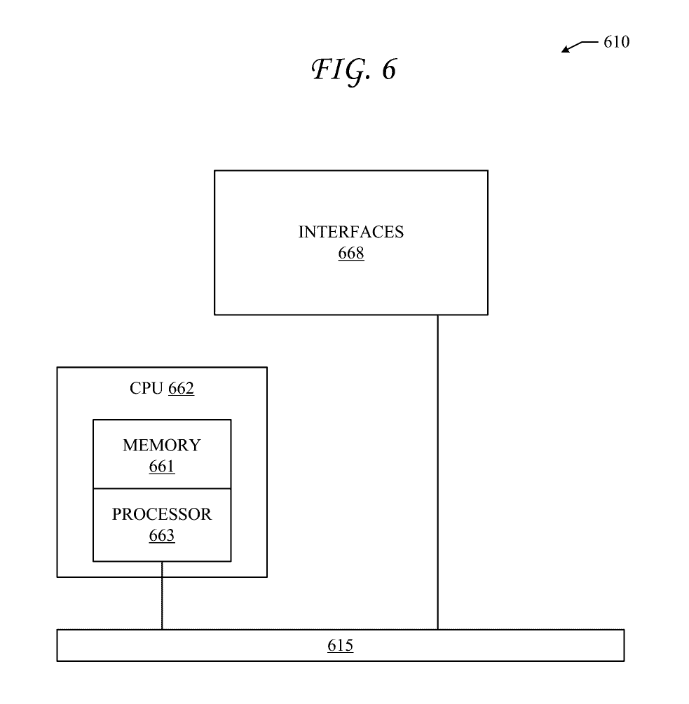

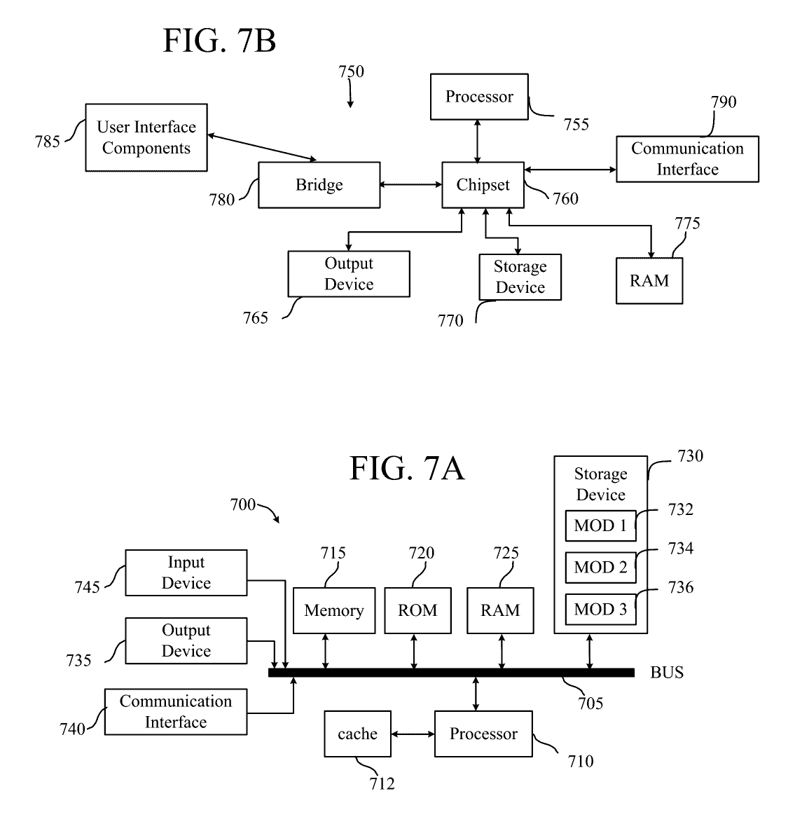

The disclosed technology addresses the need in the art for effective and efficient orchestration of virtual workloads. Disclosed are systems, methods, and computer-readable media for virtual workload orchestration or migration across cloud providers or environments. A description of network and cloud computing, and cloud computing environments and architectures as illustrated in FIGS. 1 and 2A-C, is first disclosed herein. A discussion of orchestrating or migrating virtual workloads, as illustrated in FIGS. 3-5, will then follow. The discussion then concludes with a description of example devices, as illustrated in FIGS. 6 and 7A-B. These variations shall be described herein as the various embodiments are set forth. The disclosure now turns to an introductory discussion of cloud computing.

Cloud computing can be generally defined as Internet-based computing in which computing resources are dynamically provisioned and allocated to client, user, or subscriber computers or other devices from resources available via a network (e.g., “the cloud”). In some embodiments, the resources can be provisioned and allocated on-demand. Moreover, the network or cloud can include distributed resources.

Cloud computing resources can include any type of resource such as computing resources, storage resources, network devices, virtual machines (VMs), software resources, computing environments or platforms, etc. For example, cloud computing resources may include service and/or processing devices (e.g., firewalls, web services, bandwidth services, remote access services, database services, deep packet inspectors, traffic monitors, content filtering systems, routers, etc.), storage devices (e.g., servers, network attached storages, storage area network devices, storage arrays, etc.), and so forth. Cloud computing resources can also be used for instantiation of VMs, workloads, databases, applications, services, etc.

Furthermore, the “cloud” in cloud computing may include a “private cloud,” a “public cloud,” and/or a “hybrid cloud.” A “hybrid cloud” is a cloud infrastructure composed of two or more clouds that inter-operate or federate through technology. A hybrid cloud can be an interaction between private and public clouds where a private cloud joins a public cloud and utilizes public cloud resources in a secure and scalable way. While many applications can remain within datacenters, there are other applications with compute requirements suitable for a cloud environment or infrastructure.

Datacenters can similarly provide resources, services, and/or environments for various computing needs. Moreover, datacenters can include networks, devices, and configurations to provision resources and services. In some cases, datacenters can also provision or manage compute workloads, including virtual workloads such as VM workloads. To this end, datacenters can include VMs and/or any other virtualized computing environment or platform. For example, networks and datacenters can be extended through network virtualization. Network virtualization allows hardware and software resources to be combined in a virtual network or environment. Network virtualization can also allow multiple numbers of VMs to be attached to the physical network via respective VLANs or network segments. The VMs can be grouped according to their respective VLAN, and can communicate with other VMs as well as other devices on the internal or external network.

To illustrate, a datacenter can include an underlay network and one or more overlay networks. Overlay networks generally allow virtual networks to be created and layered over a physical network infrastructure. Overlay network protocols, such as Virtual Extensible LAN (VXLAN), Network Virtualization using Generic Routing Encapsulation (NVGRE), and Stateless Transport Tunneling (STT), provide a traffic encapsulation scheme which allows network traffic to be carried across L2 and L3 networks over a logical tunnel. Such logical tunnels can be originated and terminated through virtual tunnel end points (VTEPs). The VTEPs can tunnel the traffic between an underlay network and any overlay network, such as a VXLAN, an NVGRE, or a STT, for example.

Moreover, overlay networks can include virtual segments, such as VXLAN segments in a VXLAN overlay network, which can include virtual L2 and/or L3 overlay networks over which VMs communicate. The virtual segments can be identified through a virtual network identifier (VNI), such as a VXLAN network identifier, which can specifically identify an associated virtual segment or domain.

The disclosure now turns to FIG. 1, which illustrates a schematic block diagram of an example cloud architecture 100 including nodes/devices interconnected by various methods of communication. Cloud 150 can be a public, private, and/or hybrid cloud system. Cloud 150 can include resources, such as one or more Firewalls 172; Load Balancers 180; WAN optimization platforms 170; devices 174, such as switches, routers, intrusion detection systems, content delivery systems, or any hardware or software network device; servers 178, such as dynamic host configuration protocol (DHCP) servers, domain naming system (DNS) servers, storage servers, web servers, database servers, etc.; virtual machines (VMs) 182; controllers 176, such as a cloud controller or a management device; or any other resource.

In some cases, resources 170-182 can be provisioned through one or more modules, workloads, VMs, devices, logical networks, and/or distributed components. Moreover, resources 170-182 can be configured according to one or more specific computing environments, such as operating systems and/or software platforms; policies; architectures; topologies; settings; etc.

As previously noted, cloud 150 can include cloud or computing resources. Cloud resources can be physical, software, virtual, or any combination thereof. For example, a cloud resource can include a server running one or more VMs or storing one or more databases. The cloud 150 can provision various types of resources and/or services, such as application services, storage services, management services, monitoring services, configuration services, administration services, backup services, disaster recovery services, bandwidth or performance services, intrusion detection services, VPN services, or any type of services to any device, server, network, client, or tenant. Cloud 150 can also allocate resources and/or provide infrastructure services. For example, cloud 150 can host and provision workloads or resources, such as virtual workloads as well as physical and/or virtual devices. Cloud resources and services can be provisioned or allocated based on requests (e.g., client or tenant requests), schedules, triggers, events, signals, messages, traffic management services, alerts, agreements, necessity, or any other factor.

For example, cloud 150 can provide specific services or resources for client A (110), client B (120), and client C (130). To illustrate, cloud 150 can deploy a network or specific network components, configure links or devices, provision services or functions, allocate resources or workloads, and/or provide any other services or resources for client A (110), client B (120), and client C (130). Other non-limiting example services by cloud 150 can include network administration services, network monitoring services, content filtering services, application control, WAN optimization, firewall services, gateway services, storage services, protocol configuration services, wireless deployment services, content services, application services, database services, hosting services, and so forth.

Client A (110), client B (120), and client C (130) can include tenant, customer, or subscriber networks; client devices; a datacenters; clouds; etc. In some embodiments, client A (110), client B (120), and client C (130) can each include one or more networks. For example, (110), client B (120), and client C (130) can each include one or more LANs and VLANs. In some embodiments, a client can represent one branch network, such as a LAN, or multiple branch networks, such as multiple remote networks. For example, client A (110) can represent a single LAN network or branch, or multiple branches or networks, such as a branch building or office network in Los Angeles and another branch building or office network in New York. If a client includes multiple branches or networks, the multiple branches or networks can each have a designated connection to the cloud 150. For example, each branch or network can maintain a tunnel to the cloud 150. Alternatively, all branches or networks for a specific client can connect to the cloud 150 via one or more specific branches or networks. For example, traffic for the different branches or networks of a client can be routed through one or more specific branches or networks. Further, client A (110), client B (120), and client C (130) can each include one or more routers, switches, appliances, client devices, VMs, or any other resources or devices.

Client A (110), client B (120), and client C (130) can connect with cloud 150 through networks 160, 162, and 164, respectively. For example, client A (110), client B (120), and client C (130) can each connect with cloud 150 through networks 160, 162, and 164, respectively, in order to access resources from cloud 150, communicate with cloud 150, or receive services from cloud 150. Networks 160, 162, and 164 can each include a public network, such as the Internet; a private network, such as a LAN; a combination of networks; or any other network, such as a VPN or an overlay network.

Cloud 150 can maintain information about one or more client networks in order to provide or support specific services or resources for each client, such as security or application services and/or computing resources. Cloud 150 can also maintain one or more links or tunnels to client A (110), client B (120), and/or client C (130). For example, cloud 150 can maintain a VPN tunnel to one or more devices in client A's network.

The cloud 150 can communicate data with, and/or allocate or provision resources for, client A (110), client B (120), and client C (130) through networks 160-164. To this end, client A (110), client B (120), and client C (130) can send and/or receive information to and from the cloud 150, such as configuration or application data via networks 160-164. Client A (110), client B (120), and client C (130) can also access and/or utilize resources from cloud 150 through networks 160-164. In some cases, cloud 150 can allocate one or more resources for client A (110), client B (120), and/or client C (130) dynamically, on-demand, and/or based on a request or schedule. For example, cloud 150 can host services or allocate resources for client A (110) based on a request received by cloud 150.

Those skilled in the art will understand that the cloud architecture 150 can include any number of nodes, devices, links, networks, or components. In fact, embodiments with different numbers and/or types of clients, networks, nodes, cloud components, servers, software components, devices, virtual or physical resources, configurations, topologies, services, appliances, deployments, or network devices are also contemplated herein. Further, cloud 150 can include any number or type of resources, which can be accessed and utilized by clients or tenants. The illustration and examples provided herein are for clarity and simplicity.

Moreover, as far as communications, packets (e.g., traffic and/or messages) can be exchanged among the various nodes and networks in the cloud architecture 100 using specific network protocols. In particular, packets can be exchanged using wired protocols, wireless protocols, security protocols, OSI-Layer specific protocols, or any other protocols. Some non-limiting examples of protocols can include protocols from the Internet Protocol Suite, such as TCP/IP; OSI (Open Systems Interconnection) protocols, such as L1-L7 protocols; routing protocols, such as RIP, IGP, BGP, STP, ARP, OSPF, EIGRP, NAT; or any other protocols or standards, such as HTTP, SSH, SSL, RTP, FTP, SMTP, POP, PPP, NNTP, IMAP, Telnet, SSL, SFTP, WIFI, Bluetooth, VTP, ISL, IEEE 802 standards, L2TP, IPSec, etc. In addition, various hardware and software components or devices can be implemented to facilitate communications both within a network and between networks. For example, switches, hubs, routers, access points (APs), antennas, network interface cards (NICs), modules, cables, firewalls, servers, repeaters, sensors, etc.

FIG. 2A illustrates a diagram of an example hybrid cloud 200 illustratively including networks or “clouds.” The hybrid cloud 200 can include a private cloud 205 (e.g., enterprise datacenter(s) or private network(s)) and a public cloud 210, which can be separated by a network, such as the Internet (not shown). Although current terminology refers to a hybrid cloud 200 including a private cloud and a public cloud, it should be understood that the various features of this disclosure can be practiced in other multi-cloud configurations (e.g., two clouds hosted by third party providers or two private clouds, such as enterprise datacenters, located in different locations).

The private cloud 205 and public cloud 210 can be connected via a communication link 270 between cloud gateway 225 and cloud gateway 235. Data packets and traffic can be exchanged among the devices of the hybrid cloud network using predefined network communication protocols.

Private cloud 205 and public cloud 210 can include cloud gateway 225 and cloud gateway 235, respectively, and at least one virtual machine (VM). For example, private cloud 205 can include VM1 250 and VM2 252, and public cloud 210 can include VM3 254 (and/or nested VM containers). The cloud gateway 225 can be configured as a VM running in the private cloud 205 that is responsible to establish communication link 270 for interconnecting the components in the public cloud 210 with the private cloud 205. The cloud gateway 235 may be configured as a VM running in the public cloud 210 that is responsible to establish the communication link 270 for connecting the cloud gateway 235 with cloud resources.

Private cloud 205 can also include a virtual supervisor module 230 (for example, the Nexus 1000V Switch by Cisco Systems, Inc.), a hypervisor 240 (also called a virtual machine manager or monitor) and one or more VMs 250, 252. Virtual supervisor module 230 can be used to create VMs in the public or private cloud, such as VM1 250, VM2 252, and VM3 254. Each of the VMs 250-254 can host an application or service, and can operate as if each resides in the cloud.

Hypervisor 240 can be configured by the virtual supervisor module 230, and can provide an operating system for one or more VMs. Hypervisor 240 can include computer software, firmware, and/or hardware to create and/or run one or more VMs. Moreover, hypervisor 240 can run one or more VMs on one or more computers called host machines. Each of the VMs can be referred to as a guest machine, and can run a guest operating system.

Private cloud 205 can also include a hybrid cloud manager 275, which can be a management plane VM for auto-provisioning resources within the hybrid cloud solution. The hybrid cloud manager 275 can be a management platform (which can include physical or virtual components, such as a VM) running in the private cloud 205, and can be generally responsible for providing the hybrid cloud operations, translating between private cloud and public cloud interfaces, management of cloud resources, dynamic instantiating of cloud gateways and cloud VM components (e.g., VM3 254) through the private virtualization platform and public cloud provider APIs. The hybrid cloud manager 275 may also monitor components (e.g., the cloud gateways 225, 235, one or more private application VMs, communication link 270, etc.) and/or provide high availability of those components.

Each cloud or network can include switch and/or network infrastructure for providing features and network services such as switching network traffic locally at the cloud, providing consistent enterprise network polices, allowing insertion or provisioning of various network services (e.g., load balancers, firewalls, content servers, web services, etc.). For example, private cloud 205 can include router 215 and public cloud 210 can include router 220 for routing traffic between cloud components or devices and/or within the network fabric. Moreover, the switch and/or network infrastructure can form a network topology, such as a spine-leaf or folded CLOS topology, which can include one or more switches, routers, VLANs, servers, domains, tenants, etc.

Communication link 270 can take several forms. For example, communication link 270 can include, or can be established via, a network, such as a public network (e.g., the Internet), a private network (e.g., a LAN), or a combination thereof. Communication link 270 can also include a virtual private network (VPN) or tunnel. For example, communication link 270 can utilize an open VPN overlay or an IP security (IPSec) VPN based L3 network extension.

VPN can offer secure transport connections in the cloud environment. Moreover, IPsec-VPN-based technologies can provide customers inter-datacenter network connectivity and various network topologies. IPsec-VPN-based technologies can also extend the network (e.g., cloud or enterprise datacenter) at the network layer (Layer 3 or “L3” of the OSI model). As such, overlay networks created at a cloud or datacenter (e.g., public cloud 210) can include new subnets, and VMs in the overlay(s) can be assigned new network identities (e.g., IP and MAC addresses). Specific services or applications (e.g., access control lists, firewall policies, domain name services, etc.) can be accordingly configured or modified in order for attached VM systems to communicate with the underlay.

Some hybrid cloud embodiments can utilize a secure transport layer (e.g., Layer 4 or “L4”) tunnel as the communication link 270 between a first cloud gateway 225 in a private cloud 205 and a second cloud gateway 235 in a public cloud 210. The secure transport layer tunnel can be configured to provide a link layer (e.g., Layer 2 or “L2”) network extension between the private cloud 205 and the public cloud 210. The secure transport layer (L4) tunnel (e.g., transport layer security (TLS), datagram TLS (DTLS), secure socket layer (SSL), etc.) can provide a secure L2 switch overlay that interconnects cloud resources (e.g., public cloud 210) with private clouds 205 (e.g., enterprise network backbones). In other words, the secure transport layer tunnel can provide a link layer network extension between the private cloud 205 and the public cloud 210.

As noted, cloud gateway 225 at the private cloud 205 can use an L4 Secure Tunnel to connect to cloud resources allocated at public cloud 210. The L4 secure tunnel can be used with corporate or private firewalls and NAT devices due to the nature of the transport level protocols (e.g., UDP/TCP) and the transport layer ports opened for HTTP/HTTPS in the firewall, for example. The L2 network can thus be further extended and connected to each of the cloud VMs, e.g., VM1 250, VM2 252, VM3 254, through the cloud gateway 235 at the public cloud 210. With a network overlay, instances of a particular private application VM, e.g., VM3 254, can be seamlessly migrated to the overlay network, with minimal impact to the existing corporate infrastructure.

Public cloud service providers can offer a number of network attachments for each of the cloud VMs, and network broadcasting capabilities. Moreover, an L2 network overlay on top of L4 tunnels can be used to reduce the network attachments requirements for cloud VMs and provide cloud VMs with network broadcasting abilities.

As described above, the techniques herein can allow enterprise customers to deploy enterprise-wide network architectures, even in a hybrid cloud environment. As one of ordinary skill in the art will readily recognize, the hybrid cloud 200 can include other architectures, other types of networks or clouds, additional networks or clouds, and/or more or less components, resources, links, devices, etc. Indeed, hybrid cloud 200 is provided as a non-limiting example for simplicity and explanation purposes.

Referring to FIG. 2B, one or more VMs in the hybrid cloud environment 200 can be migrated from one cloud (e.g., private cloud 205) to another cloud (e.g., public cloud 210). For example, if a VM on the private cloud 205 needs to be scaled beyond the current resources of the private cloud 205, or the private cloud 205 needs to be taken offline for a period of time, the VM—and/or any workload instances associated with the VM—can be migrated to the public cloud 210 for these and other reasons. In some cases, cloud “bursting” can be used to migrate or extend a VM or VM workload to another cloud (e.g., extend VM1 250 from private cloud 205 to public cloud 210, or migrate VM1 250 from private cloud 205 to public cloud 210 and vice versa).

VM migration can be managed using virtual supervisor module 230 and/or hybrid cloud manager 275. For example, hybrid cloud manager 275 can migrate VM1 250 by copying or moving the VM1 250 image to public cloud 210, and instantiating the VM1 250 image on the public cloud 210.

FIG. 2C illustrates a schematic diagram of an example hybrid cloud environment 260 with multiple private clouds. The hybrid cloud environment 260 can include private cloud 205, public cloud 210, and private cloud 212. Public cloud 210 can run an application or service in VM4 256. The application can be shared by the enterprise private cloud 205 and partner private cloud 212. In some cases, public cloud 210 can act as an intermediary that provides access to the private clouds 205 and 212.

FIG. 3 illustrates a schematic diagram of an example module 300 for orchestrating workload movement across providers. Module 300 allows VMs and VM workloads to be migrated or instantiated (e.g., cloud bursting) to and from different clouds, networks, datacenters, etc., such as clouds 150, 200, 260, and 302, for example.

Module 300 can include Cloud Entity 304 which can orchestrate VM workload movements to and from Cloud 302. Cloud Entity 304 can be a module, a device, an application or service, and/or any virtual, software, and/or physical component. Moreover, Cloud 302 can include one or more public, private, and/or hybrid clouds; datacenters; and/or networks. For example, Cloud 302 can include one or more clouds, such as clouds 150, 200, 260 shown in FIGS. 1 and 2A-C.

Furthermore, Cloud Entity 304 can communicate with a virtualization platform (e.g., vCenter, Microsoft SCVMM, Microsoft Hyper-V, Openstack, etc.) to download a VM image and prepare a VM template for Cloud 302 in order to orchestrate the movement of the VM associated with the VM image and/or any associated instances to Cloud 302. To this end, Cloud Entity 304 can include components 306-324 for orchestrating VM workload movements. Components 306-320 can include a Transport Adapter 306, Abstraction Layer 308, Job Manager 310, Resource Manager 312, Persistence Adapter 314, Image Entity 316, Cloud Access Component 318, Storage Component 320, and/or any additional components or adapters for workload orchestration and/or cloud computing. The components 306-320 can be modules, devices, applications, processes, and/or any software/hardware configured to perform respective operations.

Transport Adapter 306 can provide a software framework for one or more application services. Transport Adapter 306 can enable Cloud Entity 304 to call functions, processes, and/or pieces of code locally and/or remotely across one or more programming languages. For example, Transport Adapter 306 can provide a remote procedure call (RPC) framework, such as Remote Method Invocation (RMI) or Apache Thrift.

Cloud Entity 304 can include Cloud Provider Adapter 318 for preparing and/or processing the VM image and uploading the resulting VM image or template to Cloud 302. Abstraction Layer 308 can provide abstraction between Transport Adapter 306, Cloud Provider 318, and any other interface(s) or component(s). Abstraction Layer 308 can provide abstraction for one or more services implemented by the Cloud Provider Adapter 318. Abstraction Layer 308 can provide abstraction services for one or more VM images or image formats, server implementations, and/or provider implementations. For example, Abstraction Layer 308 can include an image service module for abstraction of image services (e.g., VM image type and format); a server service module for abstraction of server-specific implementations; and a provider service module for abstraction of provider-specific implementations, such as Amazon Web Services, Microsoft Azure, OpenStack, and/or any other current or future providers.

Cloud Provider Adapter 318 can include Image Processing Entity 316 to process a VM image to be moved or migrated to Cloud 302. Image Processing Entity 316 can convert a VM image (e.g., VM image downloaded from one cloud, datacenter, or virtualization platform) to a format that is appropriate for the destination cloud (e.g., cloud 302). For example, Image Processing Entity 316 can convert the downloaded VM image to a specific format such as raw disk, virtual machine disk (VMDK), qcow, etc., depending on the target or destination environment and/or platform. In some cases, Image Processing Entity 316 can perform disk format changes for a VM image using specific disk formatting tools, such as quemu-img, for example.

Image Processing Entity 316 can also provision the VM's guest operating system (OS) with the necessary hypervisor drivers, which can be based on the destination or target's hypervisor (e.g., the hypervisor of Cloud 302). For example, Image Processing Entity 316 can mount the VM image, inject or insert hypervisor drivers, and execute one or more commands to setup the drivers. Such commands or setup procedures can depend on the underlying OS or environment. For example, in a Linux environment, the hypervisor drivers can be setup in a chroot environment. On the other hand, in a Windows environment, the hypervisor drivers can be setup via registry manipulation.

Cloud Provider Adapter 318 can include specific modules, interfaces, or components (e.g., Provider 1, Provider 2, Provider N, etc.) for processing provider-specific implementations, such as Amazon Web Services, Microsoft Azure, OpenStack, and/or any other current or future providers. Since different providers can have different resources, platforms, programming languages, interfaces, architectures, hypervisors, etc., the provider modules 1-N can be tailored to the requirements and circumstances of the various, specific providers.

Cloud Provider Adapter 318 can also include a cloud Access Module 318 for interfacing with the Cloud 302. Cloud Access Module 318 can include one or more toolkits, interfaces, and/or APIs for the specific target environment of Cloud 302. For example, Cloud Access Module 318 can include an Apache jclouds cloud toolkit for the Java platform, a Representational State Transfer (REST) API for interacting with cloud providers, etc.

Cloud Entity 304 can also include Job Manager Module 310 for managing VM and workload orchestration jobs, and a Resource Manager Module 312 for managing resources used by the VMs and/or utilized for the workload orchestration. Resource Manager Module 312 can determine what resources are used by a VM that is scheduled to be moved or migrated to Cloud 302. Resource Manager Module 312 can also determine what and/or how much resources should be allocated to the VM at the target location (e.g., Cloud 302). In some cases, Resource Manager Module 312 can perform cloud fit operations for a VM by matching or allocating resources on the Cloud 302 for the VM. For example, Resource Manager Module 312 can determine what resources (e.g., what type and/or amount of resources), such as CPU, memory, storage, architecture, etc., are used by a VM on the source location and use that information to determine what resources should be allocated to the VM on the target location.

Cloud Entity 304 can also include a Persistence Adapter 314. Persistence Adapter 314 can store data, such as VM images, on Storage Location 320. Storage Location 320 can include one or more physical and/or logical disks or drives, memories, arrays, databases, servers, SANs, files, images, clusters, and/or any other storage resources. Moreover, Storage Location 320 can be located or hosted, on a single device, distributed over multiple devices, mirrored across multiple devices, etc. In some cases, Storage Location 320 can reside on the same system (e.g., server, disk, network, etc.) as the Cloud Entity 304. However, in other cases, Storage Location 320 can reside on a separate system as the Cloud Entity 304.

As one of ordinary skill in the art will readily recognize, Cloud Entity 304 can include more or less modules, components, and/or items than those illustrated in FIG. 3. Components 306-320 are presented as a non-limiting example for simplicity and explanation purposes.

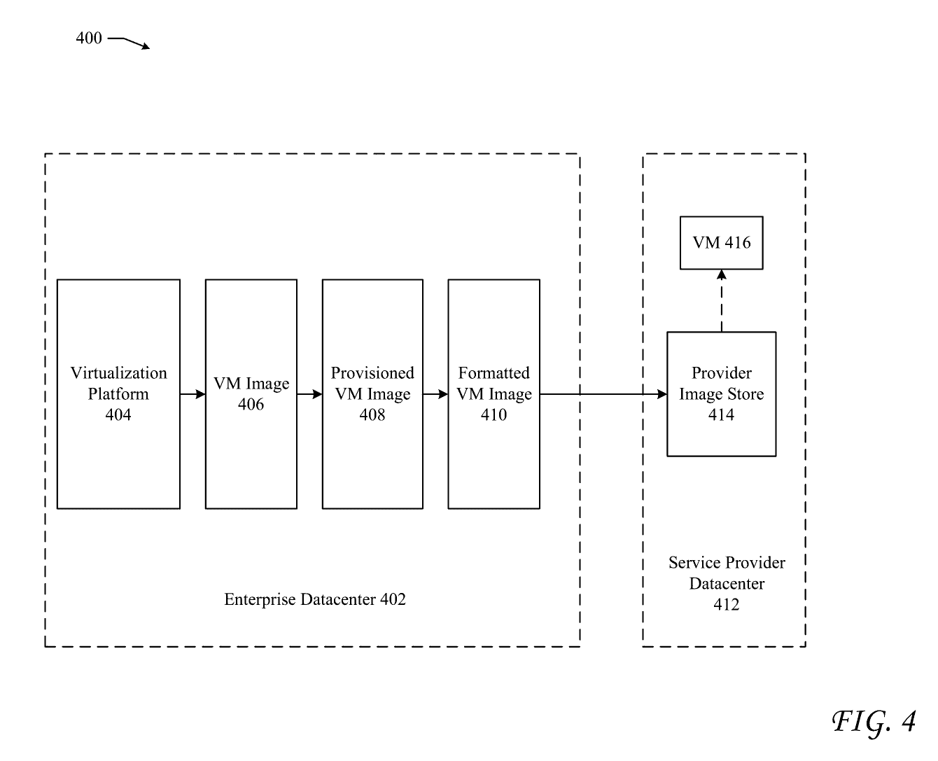

FIG. 4 illustrates a block diagram of a system 400 for orchestrating VM workloads from an Enterprise Datacenter 402 to a Service Provider Datacenter 412. As one of ordinary skill in the art will readily recognize, the Enterprise Datacenter 402 and Service Provider Datacenter 412 can represent any network, cloud, or datacenter capable of hosting virtual machines and workloads, such as illustrated in FIGS. 1 and 2A-C.

Enterprise Datacenter 402 can include a Virtualization Platform 404, such as vCenter, Microsoft SCVMM, Microsoft Hyper-V, Openstack, etc. Moreover, the Virtualization Platform 404 can include one or more VMs and VM workloads.

Enterprise Datacenter 402 can obtain or download VM Image 406 from the Virtualization Platform 404 to move the VM Image 406 and/or a workload instance of VM Image 406 to Service Provider Datacenter 412. Enterprise datacenter 402 can then take VM Image 406 and provision the guest OS for the VM with hypervisor drivers to generate Provisioned VM Image 408. The hypervisor drivers can be based on the hypervisor of Service Provider Datacenter 412. Thus, Provisioned VM Image 408 can be the VM Image 406 provisioned with the necessary or appropriate hypervisor drivers for Service Provider Datacenter 412. In some cases, the guest OS provisioning can be performed by mounting the VM Image 406, injecting the hypervisor drivers, and executing commands to set up the hypervisor drivers. The hypervisor drivers can be setup in different ways depending on the OS and/or environment. For example, the hypervisor drivers can be setup via a chroot environment for Linux-based OSs or registry manipulation in Windows-based OSs.

Enterprise Datacenter 402 can also convert the VM image to Formatted VM Image 410. Formatted VM Image 410 can be the Provisioned VM Image 408 formatted according to an appropriate format for Service Provider Datacenter 412. For example, the VM image can be formatted according to a specific format such as raw disk, virtual machine disk (VMDK), qcow, etc., depending on the virtualization platform or environment of Service Provider Datacenter 412. The VM image can be converted from one format, such as VMDK, to another format, such as VHD, using disk format tools such as quemu-img, for example.

Enterprise Datacenter 402 can then upload Formatted VM Image 410, which has been formatted and provisioned for Service Provider Datacenter 412, to Provider Image Store 414. Provider Image Store 414 can be any storage, memory, or repository associated with Service Provider Datacenter 412, where VMs and images can be uploaded to. Moreover, Enterprise Datacenter 402 can upload Formatted VM Image 410 to Provider Image Store 414 as a VM template which can be used to setup VMs and/or VM workloads/instances on Service Provider Datacenter 412 for the VM Image 406 at the Enterprise Datacenter 402. Thus, the Formatted VM Image 410 can serve as a VM template on Service Provider Datacenter 412 for launching or running VM instances and workloads for the VM Image 406, as Formatted VM Image 410 can be configured, formatted, provisioned, fit, and setup for running in the Service Provider Datacenter 412.

In some cases, Formatted VM Image 410 can be configured according to one or more resources at the Service Provider Datacenter 412. For example, Enterprise Datacenter 402 can perform a cloud fit procedure to configure the Formatted VM Image 410 according to resources, such as CPU, memory, storage, architecture, etc., at the Service Provider Datacenter 412. Thus, Enterprise Datacenter 402 can match provider resources at Service Provider Datacenter 412 with the specific instance or workload type, requirements, parameters, and/or criteria for Formatted VM Image 410.

Once the Formatted VM Image 410 has been uploaded to Provider Image Store 414, it can be used as a VM template for creating, running, launching, and/or initializing VM 416. The resulting VM 416 can be a VM and/or VM instance/workload for VM Image 406 at Service Provider Datacenter 412.

The system 400 can be implemented for orchestrating workload movements across clouds, providers, networks, and/or datacenters, such as cloud 150, 200, 260, and/or 302. For example, system 400 can be used to move VMs and/or workloads to and from Service Provider Datacenter 412. System 400 can also be used to move VMs and/or workloads to other clouds, providers, networks, and/or datacenters, and/or moving VMs and/or workloads from other clouds, providers, networks, and/or datacenters back to Enterprise Datacenter 402.

Further, system 400 can be used to move VMs and/or workloads running different guest OSs into different types of clouds, environments, and/or platforms. Indeed, system 400 can support seamless movement of VMs and/or workloads for any OS, hypervisor, format, architecture, software or service, platform, application(s), software and/or resource environment, and so forth.

While FIG. 4 illustrates movement of VM and/or workloads from Enterprise Datacenter 402 to Service Provider Datacenter 412, one of ordinary skill in the art will readily recognize that system 400 can orchestrate movement of VMs and/or workloads to and from any number and type of networks, clouds, and/or datacenters. In fact, Enterprise Datacenter 402 and Service Provider Datacenter 412 are provided in FIG. 4 as a non-limiting example for simplicity and explanation purposes.

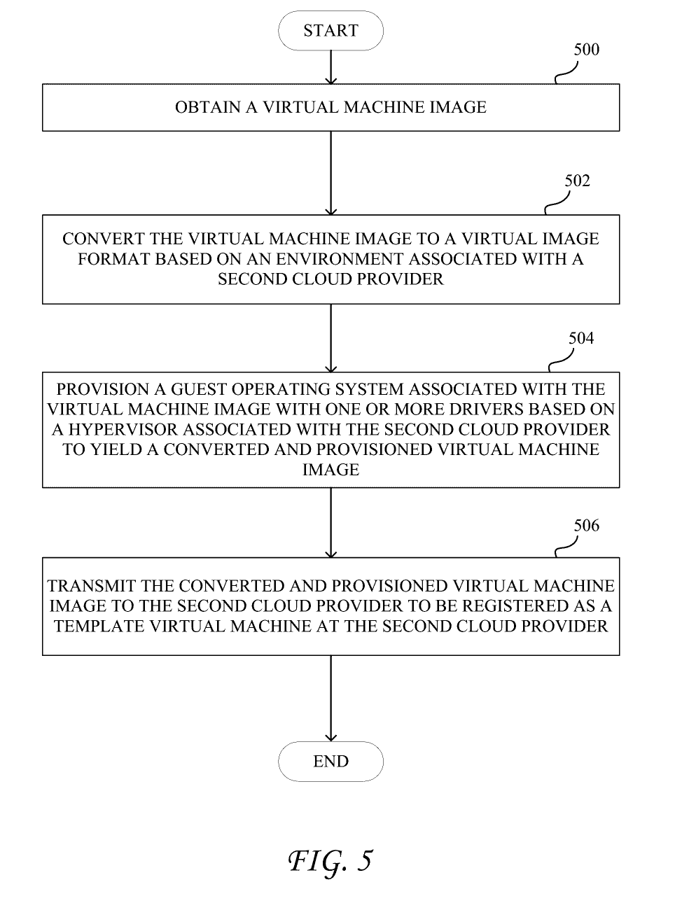

Having disclosed some basic system components and concepts, the disclosure now turns to the example method embodiment shown in FIG. 5. For the sake of clarity, the method is described in terms of cloud entity 304, as shown in FIG. 3, configured to practice the method. The steps outlined herein are exemplary and can be implemented in any combination thereof, including combinations that exclude, add, or modify certain steps.

At step 500, cloud entity 304 can obtain a virtual machine image. For example, cloud entity 304 can download the virtual machine image to a local storage or repository. Further, the virtual machine image can be associated with a first service provider. For example, the virtual machine image can be associated with a virtual machine hosted by the first service provider. The first service provider can be a datacenter or cloud, such as cloud 150, 200, 260, and/or 302. In some cases, cloud entity 304 can reside within the first service provider. However, in other cases, cloud entity 304 can be separate from the first service provider. For example, cloud entity 304 can be a separate enterprise entity.

The virtual machine associated with the virtual machine image can be configured to run one or more applications, such as a web application, and/or provision one or more services or workloads. Moreover, the virtual machine associated with the virtual machine image can be configured according to any specific guest operating system and/or hypervisor. The virtual machine image can be downloaded and/or stored in a specific virtual disk format, such as VHD or VMDK, for example.

At step 502, cloud entity 304 can convert the virtual machine image to a virtual image format based on an environment of a second cloud provider. For example, cloud entity 304 can convert the virtual machine image based on a hypervisor, disk format, and/or platform used by the second cloud provider. The cloud entity 304 can convert the virtual machine image to a format appropriate for the second cloud provider, such as raw, VMDK, qcow, etc. To this end, the cloud entity 304 can perform disk format changes. For example, cloud entity 304 can convert a VM disk from VMDK to VHD.

The second cloud provider can be a different provider than the first cloud provider associated with the virtual machine image. However, in some cases, the second cloud provider can be the same cloud provider as the first cloud provider. For example, the second cloud provider can be a segment of the same network, datacenter, or cloud of the first cloud provider running a different hypervisor, platform, and/or environment as a segment of the first cloud provider hosting the virtual machine image. Thus, cloud entity 304 can convert the virtual machine image from a format used by the virtual machine image to a different format so it can be moved to a different area within the first cloud provider.

At step 504, the cloud entity 304 can provision a guest operating system associated with the virtual machine image with one or more drivers based on a hypervisor associated with the second cloud provider to yield a converted and provisioned virtual machine image. In other words, cloud entity 304 can provision the guest operating system for the virtual machine image based on the hypervisor used by the second cloud provider. The cloud entity 304 can provision the guest operating system with drivers by mounting the virtual machine image, injecting or inserting the hypervisor drivers into the virtual machine image, and executing one or more commands to setup the hypervisor drivers on the virtual machine image.

At step 506, cloud entity 304 can then transmit the converted and provisioned virtual machine image to the second cloud provider to be registered as a template virtual machine at the second cloud provider. For example, cloud entity 304 can upload the converted and provisioned virtual machine image to the second cloud provider for use as a virtual machine template at the second cloud provider.

The resulting template virtual machine image can be used to launch, initialize, and/or instantiate instances or workloads from the template virtual machine. Thus, by creating template virtual machine images specifically designed for a target location (e.g., cloud or datacenter), the cloud entity 304 can move virtual machines from a source location to the target location, and run workloads or instances for the virtual machine on the target location. Virtual machines and workloads can consequently be moved back and forth to and from different clouds, networks, datacenters, etc., despite any differences in the environments, resources, platforms, architectures, etc. Such orchestration of workload and virtual machine movements can be supported for any operating system and/or hypervisor.

In addition, such orchestration of workload and virtual machine movements can be used to launch or initiate any number of instances or workloads on any number of targets. Indeed, such orchestration of workload and virtual machine movements can enable seamless workload movement back and forth to different entities, clouds, networks, datacenters, etc., any number of times. For example, in some embodiments, cloud entity 304 can generate template virtual machine images for any number and type of targets and move or burst workloads in and out of the different targets.

In some embodiments, cloud entity 304 can select an appropriate instance type for a virtual machine (e.g., cloud fit) on the target location (e.g., the second cloud provider) based on the source location's (e.g., first cloud provider) resources, such as CPU, memory, storage, architecture, etc.

The disclosure now turns to the example devices shown in FIGS. 6 and 7A-B. FIG. 6 illustrates an example network device 610 suitable for routing, switching, forwarding, traffic management, and load balancing. Network device 610 can be, for example, a router, a switch, a controller, a server, a gateway, and/or any other L2 and/or L3 device.

Network device 610 can include a master central processing unit (CPU) 662, interfaces 668, and a bus 615 (e.g., a PCI bus). When acting under the control of appropriate software or firmware, the CPU 662 is responsible for executing packet management, error detection, load balancing operations, and/or routing functions. The CPU 662 can accomplish all these functions under the control of software including an operating system and any appropriate applications software. CPU 662 may include one or more processors 663, such as a processor from the Motorola family of microprocessors or the MIPS family of microprocessors. In an alternative embodiment, processor 663 is specially designed hardware for controlling the operations of network device 610. In a specific embodiment, a memory 661 (such as non-volatile RAM and/or ROM) also forms part of CPU 662. However, there are many different ways in which memory could be coupled to the system.

The interfaces 668 are typically provided as interface cards (sometimes referred to as “line cards”). Generally, they control the sending and receiving of data packets over the network and sometimes support other peripherals used with the network device 610. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor 662 to efficiently perform routing computations, network diagnostics, security functions, etc.

Although the system shown in FIG. 6 is one specific network device of the present invention, it is by no means the only network device architecture on which the present invention can be implemented. For example, an architecture having a single processor that handles communications as well as routing computations, etc. is often used. Further, other types of interfaces and media could also be used with the router.

Regardless of the network device's configuration, it may employ one or more memories or memory modules (including memory 661) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc.

FIG. 7A and FIG. 7B illustrate example system embodiments. The more appropriate embodiment will be apparent to those of ordinary skill in the art when practicing the present technology. Persons of ordinary skill in the art will also readily appreciate that other system embodiments are possible.

FIG. 7A illustrates a conventional system bus computing system architecture 700 wherein the components of the system are in electrical communication with each other using a bus 705. Exemplary system 700 includes a processing unit (CPU or processor) 710 and a system bus 705 that couples various system components including the system memory 715, such as read only memory (ROM) 720 and random access memory (RAM) 725, to the processor 710. The system 700 can include a cache of high-speed memory connected directly with, in close proximity to, or integrated as part of the processor 710. The system 700 can copy data from the memory 715 and/or the storage device 730 to the cache 712 for quick access by the processor 710. In this way, the cache can provide a performance boost that avoids processor 710 delays while waiting for data. These and other modules can control or be configured to control the processor 710 to perform various actions. Other system memory 715 may be available for use as well. The memory 715 can include multiple different types of memory with different performance characteristics. The processor 710 can include any general purpose processor and a hardware module or software module, such as module 1 732, module 2 734, and module 3 736 stored in storage device 730, configured to control the processor 710 as well as a special-purpose processor where software instructions are incorporated into the actual processor design. The processor 710 may essentially be a completely self-contained computing system, containing multiple cores or processors, a bus, memory controller, cache, etc. A multi-core processor may be symmetric or asymmetric.

To enable user interaction with the computing device 700, an input device 745 can represent any number of input mechanisms, such as a microphone for speech, a touch-sensitive screen for gesture or graphical input, keyboard, mouse, motion input, speech and so forth. An output device 735 can also be one or more of a number of output mechanisms known to those of skill in the art. In some instances, multimodal systems can enable a user to provide multiple types of input to communicate with the computing device 700. The communications interface 740 can generally govern and manage the user input and system output. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 725, read only memory (ROM) 720, and hybrids thereof.

The storage device 730 can include software modules 732, 734, 736 for controlling the processor 710. Other hardware or software modules are contemplated. The storage device 730 can be connected to the system bus 705. In one aspect, a hardware module that performs a particular function can include the software component stored in a computer-readable medium in connection with the necessary hardware components, such as the processor 710, bus 705, display 735, and so forth, to carry out the function.

FIG. 7B illustrates an example computer system 750 having a chipset architecture that can be used in executing the described method and generating and displaying a graphical user interface (GUI). Computer system 750 is an example of computer hardware, software, and firmware that can be used to implement the disclosed technology. System 750 can include a processor 755, representative of any number of physically and/or logically distinct resources capable of executing software, firmware, and hardware configured to perform identified computations. Processor 755 can communicate with a chipset 760 that can control input to and output from processor 755. In this example, chipset 760 outputs information to output device 765, such as a display, and can read and write information to storage device 770, which can include magnetic media, and solid state media, for example. Chipset 760 can also read data from and write data to RAM 775. A bridge 780 for interfacing with a variety of user interface components 785 can be provided for interfacing with chipset 760. Such user interface components 785 can include a keyboard, a microphone, touch detection and processing circuitry, a pointing device, such as a mouse, and so on. In general, inputs to system 750 can come from any of a variety of sources, machine generated and/or human generated.

Chipset 760 can also interface with one or more communication interfaces 790 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 755 analyzing data stored in storage 770 or 775. Further, the machine can receive inputs from a user via user interface components 785 and execute appropriate functions, such as browsing functions by interpreting these inputs using processor 755.

It can be appreciated that example systems 700 and 750 can have more than one processor 710 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Moreover, claim language reciting “at least one of” a set indicates that one member of the set or multiple members of the set satisfy the claim.

1. A method comprising:
obtaining a first virtual machine image associated with a first compute environment, the first virtual machine image comprising a first type of virtual machine disk file and a first guest operating system;
generating, based on the first virtual machine image, a second virtual machine image tailored for a second compute environment that is different than the first compute environment, the second virtual machine image comprising a second type of virtual machine disk file and a second guest operating system, wherein the second type of virtual machine disk file is different than the first type of virtual machine disk file, the second type of virtual machine disk file being determined based on an environment associated with the second compute environment; and
provisioning, for the second virtual machine image, the second guest operating system with one or more drivers corresponding to a hypervisor associated with the second compute environment; and
migrating the second virtual machine image to the second compute environment as a template virtual machine tailored for the second compute environment.

2. The method of claim 1, further comprising transmitting a signal to the second compute environment configured to trigger a launching of a workload instance on the template virtual machine at the second compute environment.

3. The method of claim 1, further comprising:
receiving a third virtual machine image comprising a workload instance running on the template virtual machine at the second compute environment;
converting the third virtual machine image to a different virtual machine type based on a second hypervisor associated with the first compute environment, to yield a formatted virtual machine image; and
generating a second workload instance at the first compute environment based on the converted third virtual machine image.

4. The method of claim 1, wherein the first compute environment comprises a first cloud provider and the second compute environment comprises a second cloud provider, and wherein the first guest operating system is different than the second operating system.

5. The method of claim 1, further comprising:
identifying a difference between one or more resources at the first compute environment and the one or more resources at the second compute environment, the one or more resources comprising at least one of a memory, a storage, a processor, and an architecture; and
based on the difference, selecting a virtual machine workload instance type to run at the second compute environment based on the template virtual machine.

6. The method of claim 1, wherein the first virtual machine image comprises a virtual machine workload running on the first guest operating system at the first compute environment, and the method further comprising:
extracting the virtual machine workload from an associated virtual machine running the virtual machine workload at the first compute environment;
moving the virtual machine workload, without the associated virtual machine, to run on the template virtual machine at the second compute environment.

7. The method of claim 1, further comprising:
uploading the second virtual machine image to the second compute environment; and
after uploading the second virtual machine image, registering the second virtual machine image as the template virtual machine at the second compute environment.

8. The method of claim 1, wherein generating the second virtual machine image comprises performing a disk format change for changing a file type associated with the first virtual machine image from the first type of virtual machine disk file to the second type of virtual machine disk file, and wherein provisioning the second guest operating system with one or more drivers comprises:
mounting the second virtual machine image;
injecting the one or more drivers; and
executing a command to setup or configure the one or more drivers.

9. A non-transitory computer-readable storage device having stored therein instructions which, when executed by a processor, cause the processor to perform operations comprising:
obtaining a first virtual machine image associated with a first compute environment, the first virtual machine image comprising a first type of virtual machine disk file and a first guest operating system;
generating, based on the first virtual machine image, a second virtual machine image tailored for a second compute environment that is different than the first compute environment, the second virtual machine image comprising a second type of virtual machine disk file and a second guest operating system, the second type of virtual machine disk file being determined based on an environment associated with the second compute environment;
provisioning, for the second virtual machine image, the second guest operating system with one or more drivers corresponding to a hypervisor associated with the second compute environment; and
migrating the second virtual machine image to the second compute environment as a template virtual machine tailored for the second compute environment.

10. The non-transitory computer-readable storage device of claim 9, storing additional instructions which, when executed by the processor, cause the processor to perform an operation further comprising transmitting a signal to the second compute environment for initializing a virtual machine workload instance at the second compute environment.

11. The non-transitory computer-readable storage device of claim 9, storing additional instructions which, when executed by the processor, cause the processor to perform operations further comprising:
receiving a third virtual machine image comprising a virtual machine workload instance running on the template virtual machine at the second compute environment;
converting the third virtual machine image to a virtual machine of a different type based on a second hypervisor associated with the first compute environment to yield a formatted virtual machine image; and
launching a second virtual machine workload instance at the first compute environment based on the formatted virtual machine image.

12. The non-transitory computer-readable storage device of claim 9, wherein generating the second virtual machine image comprises changing a disk file type associated with the first virtual machine image from the first type to the second type, and wherein provisioning the second guest operating system with one or more drivers comprises:
mounting the second virtual machine image;
injecting the one or more drivers; and
executing a command to setup or configure the one or more drivers.

13. The non-transitory computer-readable storage device of claim 9,
wherein the first virtual machine image comprises a virtual machine workload running on the first guest operating system at the first compute environment, and the non-transitory computer-readable storage device having stored therein additional instructions which, when executed by the processor, cause the processor to perform operations comprising:
extracting the virtual machine workload from an associated virtual machine running the virtual machine workload at the first compute environment;
moving the virtual machine workload, without the associated virtual machine, to run on the template virtual machine at the second compute environment.

14. The non-transitory computer-readable storage device of claim 9, storing additional instructions which, when executed by the processor, cause the processor to perform operations comprising:
uploading the second virtual machine image to the second compute environment; and
after uploading the second virtual machine image, registering the second virtual machine image as the template virtual machine at the second compute environment.

15. A system comprising:
a processor; and
a computer-readable storage medium having stored therein instructions which, when executed by a processor, causes the processor to perform operations comprising:
obtaining a first virtual machine image associated with a first compute environment, the first virtual machine image comprising a first type of virtual machine disk file and a first guest operating system;
generating, based on the first virtual machine image, a second virtual machine image tailored for a second compute environment that is different than the first compute environment, the second virtual machine image comprising a second type of virtual machine disk type and a second guest operating system, the second type of virtual machine disk file being determined based on an environment associated with the second compute environment;
provisioning, for the second virtual machine image, the second guest operating system with one or more drivers corresponding to a hypervisor associated with the second compute; and
transmitting the second virtual machine image to the second compute environment as a template virtual machine tailored for the second compute environment.

16. The system of claim 15, wherein the first compute environment and the second compute environment comprise different cloud providers, and wherein the first guest operating system is different than the second guest operating system.

17. The system of claim 15, wherein the computer-readable storage medium stores additional instructions which, when executed by the processor, cause the processor to perform an operation comprising transmitting a signal to the second compute environment configured to trigger the second compute environment to initialize a workload instance on the template virtual machine at the second compute environment.

18. The system of claim 17, wherein the computer-readable storage medium stores additional instructions which, when executed by the processor, cause the processor to perform an operation comprising initializing, at the first compute environment, a second workload instance on a virtual machine associated with the first virtual machine image.

19. The system of claim 15, wherein generating the second virtual machine image comprises performing a disk format change for changing a virtual machine disk from a first type of virtual disk to a second type of virtual disk, and wherein provisioning the second guest operating system with one or more drivers comprises:
mounting the second virtual machine image;
injecting the one or more drivers; and
executing a command to setup or configure the one or more drivers.

20. The system of claim 15, wherein the computer-readable storage medium stores additional instructions which, when executed by the processor, cause the processor to perform operations comprising:
receiving a third virtual machine image comprising a virtual machine workload instance running on the template virtual machine at the second compute environment;
converting the third virtual machine image to a different type of virtual machine based on a second hypervisor associated with the first compute environment to yield a formatted virtual machine image; and
initializing a second virtual machine workload instance at the first compute environment based on the formatted virtual machine image.
